(19) United States
(12) Patent Application Publication
(10) Pub. No.: US 2009/0166228 A1
(43) Pub. Date: Jul. 2, 2009

(54) Memorabilia cases

(76) Inventor: Troy Robert Kinunen, New Berlin, WI (US)

Correspondence Address: RYAN KROMHOLZ & MANION, S.C., POST OFFICE BOX 26618, MILWAUKEE, WI, 53226, US

(21) Appl. No.: 12/005,195

(22) Filed: Dec. 26, 2007

(51) Int. Cl. G09F 11/00

(52) U.S. Cl. 206/1.5

(57) ABSTRACT

A memorabilia case according to the present invention includes a cover and a base that are manually engageable into a locking relationship. The case may further include a suspension means for preventing physical contact between an article of memorabilia and the case housing in at least one direction. The locking relationship is provided by at least one locking mechanism including a cleat and cooperating socket. For added protection, the locking mechanism may be obscured from access by a security flange. The case further includes a tamper detection means to determine certain attempted accesses to a display cavity formed within the case.

### BACKGROUND OF THE INVENTION

The present invention relates generally to containers and more specifically to manually engageable locking containers for articles of memorabilia where the container preferably includes access detection means.

There currently exist many display cases used to exhibit memorabilia, such as sports collectibles, coins and autograph and picture cards. Generally, memorabilia display cases fall into two categories. One category of cases allows the selective insertion and removal of the article to be displayed. The second category of prior cases provides for secure containment of an article to be displayed. Cases of the first type are generally convenient for a casual volatile display of articles, while cases of the second type are intended for authentication, grading and preservation.

Cases adapted for casual volatile display of articles generally feature a convenient way of engaging the case to contain an article of memorabilia. Such convenience may be supplied by manually engageable structures, such as pressure fit mechanisms, threaded case engagements, or releasable clip mechanisms. Cases adapted for authentication, grading and preservation are generally sealed in some manner, usually by way of ultrasonically bonding portions of the case together, for example. While the manual engagement of cases of the first type is convenient, the security of such cases is less than desirable for an authenticated piece of memorabilia. Likewise, while the permanence of ultrasonic bonding of cases of the second type provides excellent protection and security for articles of memorabilia, the equipment required to perform such bonding is not inexpensive and is not very portable.

Thus, the art of displaying articles of memorabilia would benefit from a case that includes convenient and inexpensive assembly and further includes a security mechanism.

### SUMMARY OF THE INVENTION

The present invention provides a memorabilia case that includes convenient and inexpensive assembly and further includes a security mechanism as a manually engageable locking container having access detection means.

A memorabilia case according to the present invention includes a cover having a cover top wall and a cover side wall coupled to the cover top wall. The coupling may be provided by forming the cover top wall integrally with the cover side wall. Such case also includes a base having a base top wall and a base side wall coupled to the base top wall. The coupling may be provided by forming the base top wall integrally with the base side wall. The manually engageable security is provided by at least one but perhaps five or more locking mechanisms where each locking mechanism includes cooperating structure on the cover and on the base. The locking mechanism may be provided within a seam created by the interface of the cover and the base. Furthermore, a security flange is adapted to obscure access to the cooperating locking mechanism structures. Such security flange may be coupled to and may be formed integrally with the cover. When the cover and the base are engaged in a locking relationship, there is a display cavity that is formed. A majority of the display cavity may be formed by the cover top wall and cover side wall. Alternatively, the majority of the display cavity may be formed by the cover top wall, alone.

A memorabilia case according to the present invention may also include a suspension means for preventing contact between a contained article of memorabilia and desired walls of the case. For instance, a plurality of support pedestals may project from the base top wall. The pedestals may be provided with contact pads adapted to interface with the article of memorabilia. The pedestals may be spatially arranged to interface to predetermined contact points of a predetermined article of memorabilia, such as the stitched seams of a baseball. Another example of a suspension means may be an elastomeric gasket for placement around the article of memorabilia, such as a ring to be placed around a pin-back button.

A memorabilia case according to the present invention may also include a desiccant chamber coupled to said base. The case may include a display cavity formed when the cover and the base are engaged in the locking relationship, and the desiccant chamber may be formed integrally with the base and in fluid communication with the display cavity.

A case adapted to hold an article of memorabilia may include an improvement according to the present invention, where the improvement includes a manually engageable security lock including a cleat, a socket cooperating with the cleat, and a security flange that obscures access to the cooperating junction of the cleat and the socket. The improvement may further include a tamper detection means that indicates attempted access to the case after the security lock has been manually engaged. The tamper detection means may include a fracturability of the security flange caused by a separating force of a magnitude less than is required to disengage the security lock.

### BRIEF DESCRIPTION OF THE DRAWINGS

FIG. 1 is a perspective view of a first embodiment of the present invention.

FIG. 2 is an exploded view of the embodiment of FIG. 1.

FIG. 3 is a cross-section view taken along line 3-3 of FIG. 1.

FIG. 4 is a side elevation view of the embodiment of FIG. 1.

FIG. 5 is a perspective view of a second embodiment of the present invention.

FIG. 6 is an exploded view of the embodiment of FIG. 5.

FIG. 7 is a cross-section view taken along line 7-7 of FIG. 5.

FIG. 8 is a side elevation view of the embodiment of FIG. 5.

FIG. 9 is a perspective view of a third embodiment of the present invention.

FIG. 10 is an exploded view of the embodiment of FIG. 9.

FIG. 11 is a cross-section view taken along line 11-11 of FIG. 9.

FIG. 12 is a side elevation view of the embodiment of FIG. 9.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

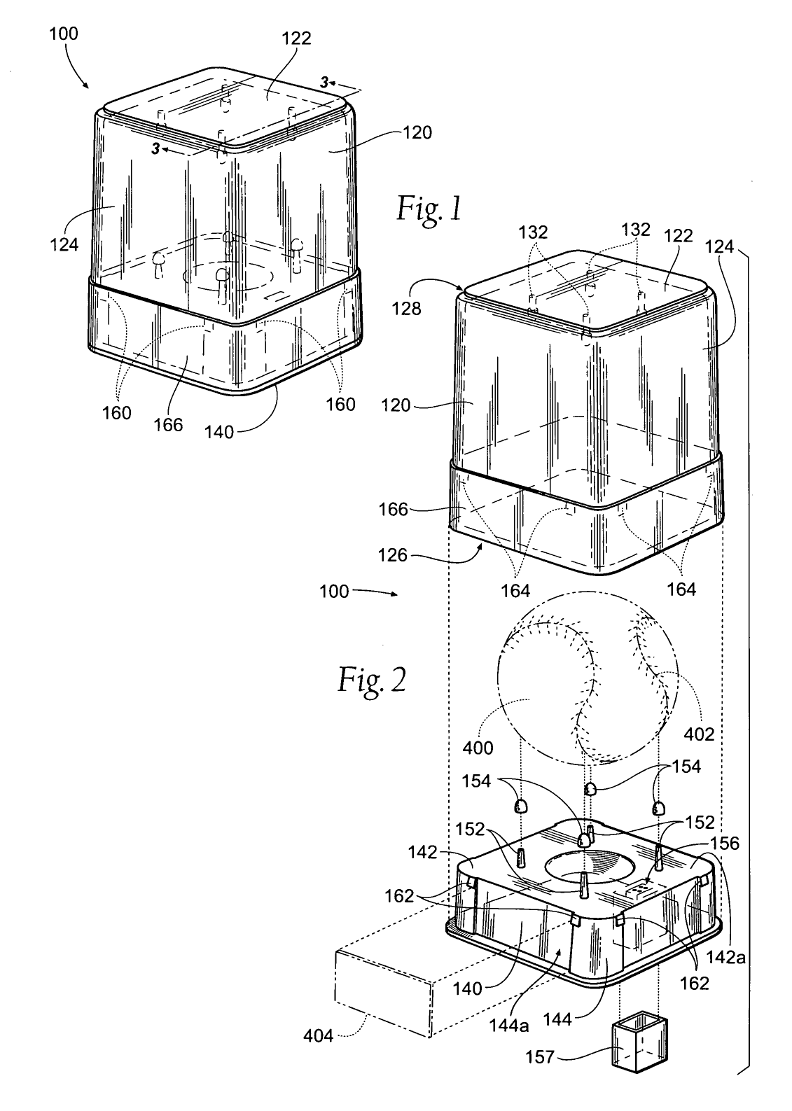

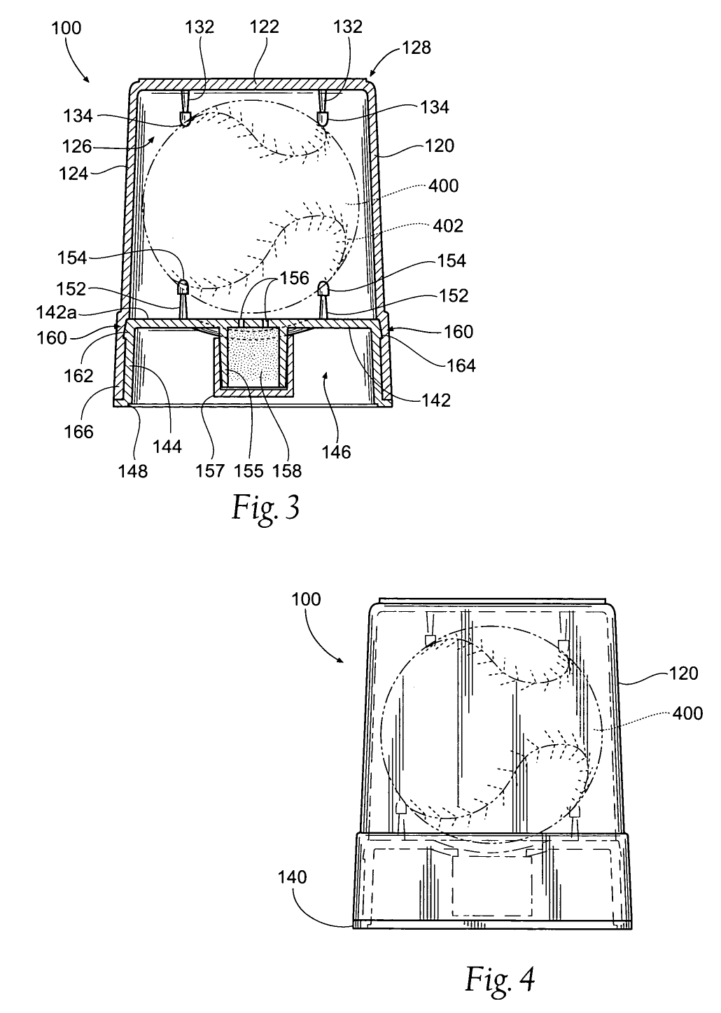

Turning now to the figures, FIGS. 1-4 show a first embodiment 100 of a memorabilia case according to the present invention. This embodiment 100 includes a cover 120 and a base 140, and is designed to contain preferably an article of memorabilia to be at least partially suspended in the case 100, such as a baseball 400. The cover 120 has a cover top wall 122 and a cover side wall 124 coupled to the cover top wall 122 to form a display cavity 126. The top wall 122 of the cover 120 is generally planar, but it may have a stacking structure 128, such as a stacking lip, formed thereon. The case 100 may be provided with a suspension means for preventing contact between a contained article of memorabilia and desired walls of the case 100. For instance, extending into the cavity 126, preferably from the top wall 122, may be at least one but preferably a plurality of stabilization pedestals 132. Each stabilization pedestal 132 is preferably provided with a contact pad 134 that may be friction fitted or otherwise coupled to the pedestal 132. If the pedestals 132 are provided on the cover 120, the spatial arrangement of the pedestals 132 is preferably such that contact with the article of memorabilia 400 by the pedestals 132 or pads 134 is at points on the article 400 that are not likely to include an autograph. Such points may include, for example, the seams 402 of the baseball 400. The cover 120 may also be provided without stabilization pedestals 132, in which case a portion of the article 400 may rest against the top wall 122 of the cover 120. The cover 120 is preferably formed by injection molding, and the side wall 124 is preferably coupled to the top wall 122 by being integrally formed with the top wall 122. The cover 120 is formed from a preferably substantially transparent material, such as a clear plastic material.

The base 140 generally has a base top wall 142 and a base side wall 144 coupled to the base top wall 142, which may form a base cavity 146. The base top wall 142 has a display surface 142a. On a portion of the base side wall 144, opposite the display surface 142a, a stacking mechanism 148, such as a stacking lip, may be provided. The base stacking lip 148 of one case 100 is thus designed to cooperate with the cover stacking lip 128 of a second case 100, thereby providing stabilized stackability. A portion of the base side wall 144 may be provided with a recessed display channel 144a, that is adapted to receive a certificate or placard 404. Extending from the display surface 142a, and generally away from the base 140, is at least one but preferably a plurality of support pedestals 152. Each support pedestal 152 is preferably provided with a contact pad 154 that may be friction fitted or otherwise coupled to the pedestal 152. The base 140 may also incorporate a desiccant chamber 155. The chamber 155 may depend from the base top wall 142 and extend opposite the display surface 142a, into the base cavity 146. When the case 100 is assembled, the desiccant chamber 155 is in fluid communication with at least a portion of the display cavity 126. Such fluid communication may be provided by way of at least one aperture 156, formed through the base top wall 142 in the embodiment 100 shown. The desiccant chamber 155 may be provided with a chamber cover 157, which is preferably selectively removable from the case 100 to allow for replacement of a desiccant material 158 contained in the chamber 155.

The cover 120 and base 140 are held together in a manually engageable secure relationship by a plurality of security latches 160. Each security latch 160 comprises a security cleat 162 and a cooperating security socket 164. Access to the security latches 160 is preferably obscured by a security flange 166, which may depend from and/or be integrally formed with the cover 120 or the base 140. The case 100 preferably features a means for indicating attempted access or tampering. An example of such means for indicating attempted access or tampering may be the frangible nature of the cover 120, the base 140 or the security flange 166. Thus, materials may be chosen to provide a desired fracture of the cover 120, the base 140 or the security flange 166, upon attempted access to the display cavity 126. In one embodiment, the force required to unlatch the security latches 160, which are preventing access to the display cavity 126, is greater than the force required to cause a fracture visible to the naked eye in the security flange 166. That is, a fracture of the security flange 166 will occur before the security latches 166 release, thereby indicating attempted access to the display cavity 126.

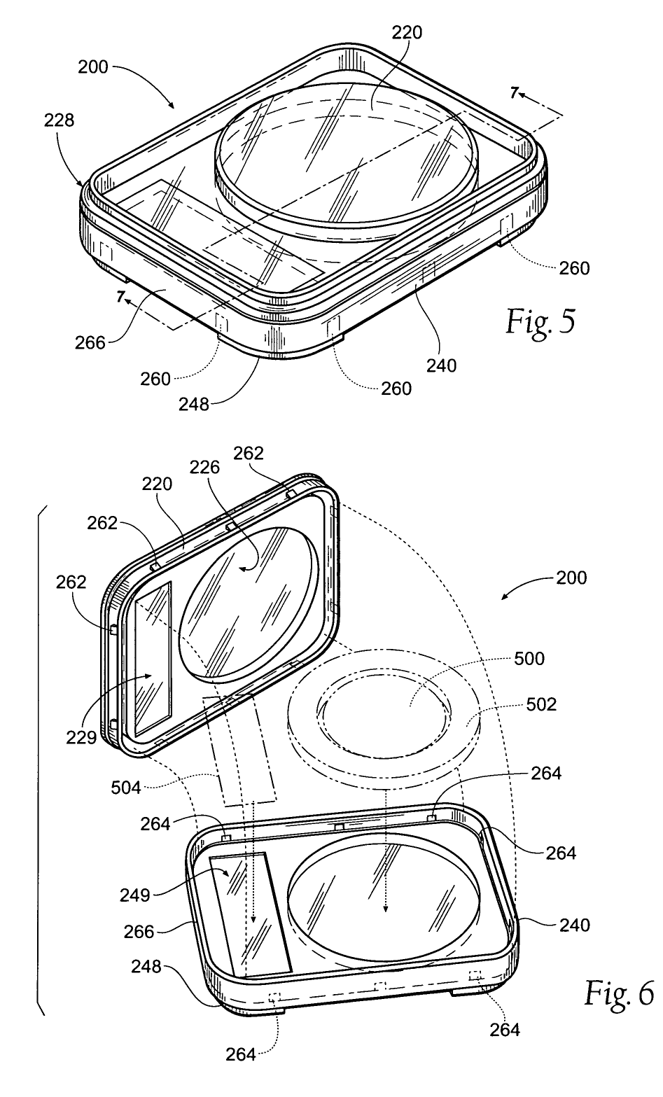

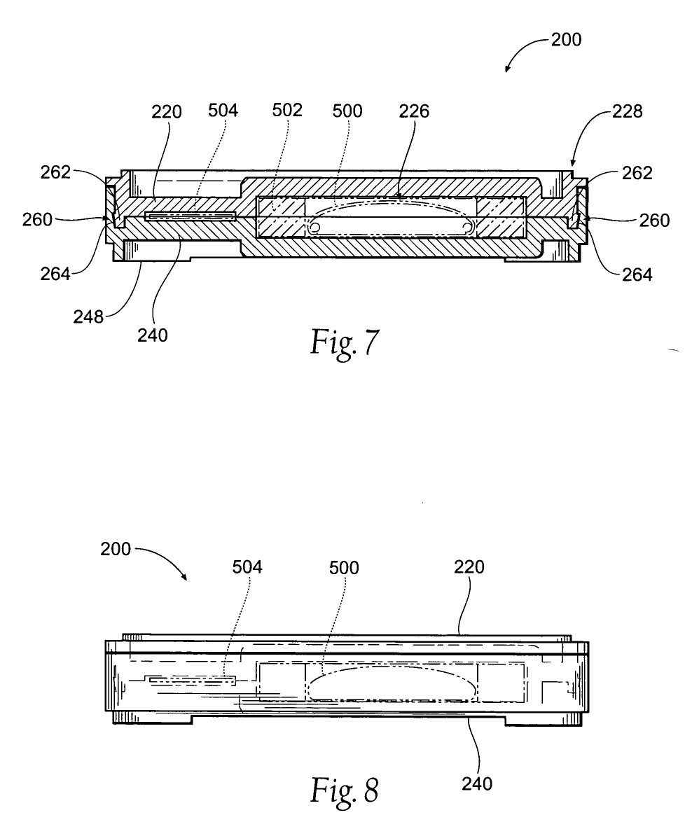

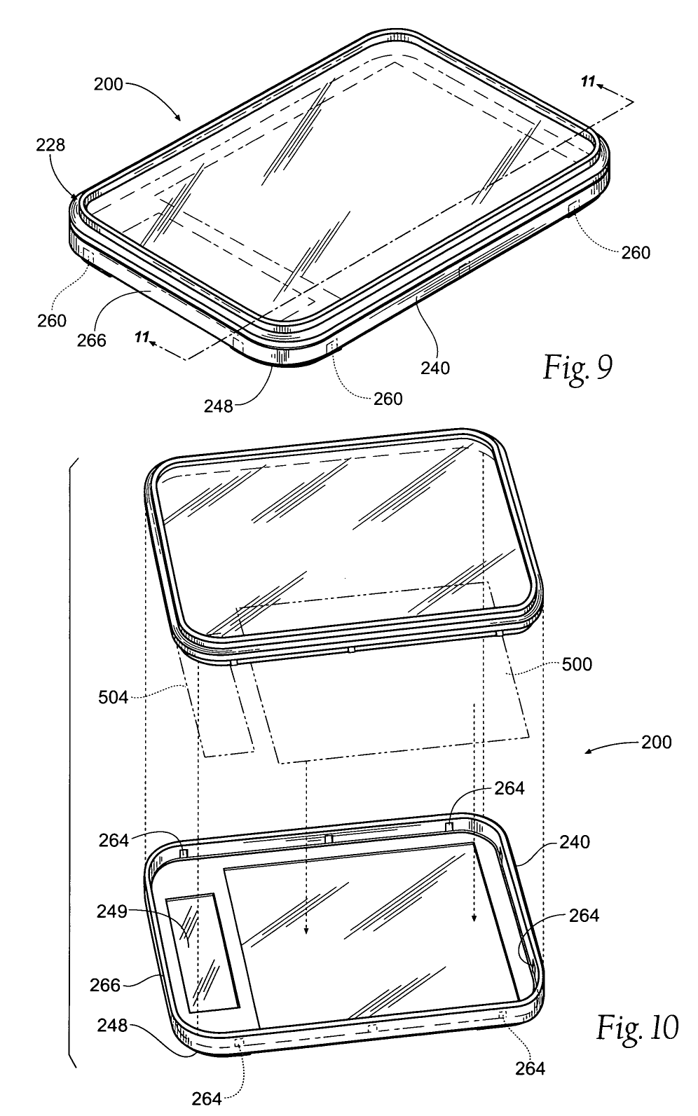

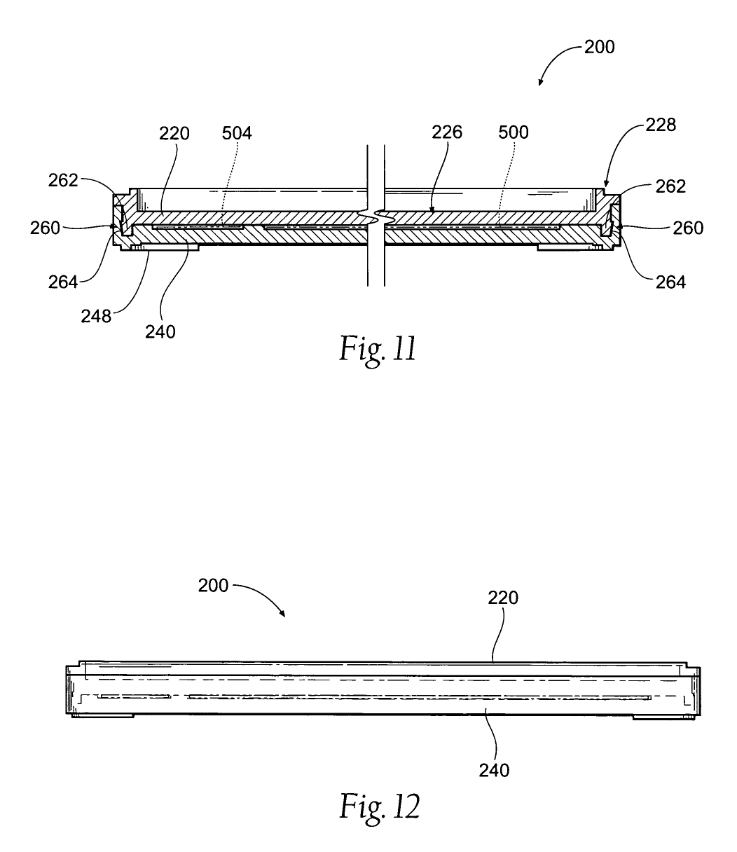

FIGS. 5-8 provides a second embodiment 200 of a memorabilia case according to the present invention. While the first embodiment 100 was preferably adapted to hold a three-dimensional article of memorabilia, such as the baseball 400, the second embodiment 200 is preferably adapted to hold securely a generally planar article of memorabilia 500, such as a pin-back button, a coin, or in the case of the alternative embodiment in FIGS. 9-12, an autograph and/or picture card. Though such planar articles 500 are necessarily three-dimensional, the articles 500 extend significantly further into two dimensions than they do into the third dimension. That is, the thickness of a planar article 500 is significantly less than the length or width of the planar article 500.

The second embodiment 200, like the first embodiment 100, includes a cover 220 and a base 240. The cover 220 has a cover top wall 222 and a cover side wall 224 coupled to or formed integrally with the cover top wall 222. The cover 220 preferably forms at least a portion of a display cavity 226. Alternatively, the cover 220 may form all or substantially all of the display cavity 226 with the base 240 simply covering the cavity 226. Alternatively, the cover 220 may simply cover the cavity 226, all or substantially all of which is formed by the base 240. The display cavity 226 shown in FIGS. 5-8 is generally cylindrical, however the invention is not limited to the shape of the cavity 226. The side wall 224 of the cover 220 preferably includes a stacking structure 228, such as a stacking lip, formed thereon. Additionally, the cover top wall 222 may be provided with a recessed display channel 229 adapted to contain a certificate or placard 504. The display channel 229 may oppose a base display channel 249, adapted to cooperate with the cover display channel 229 to contain the placard 504. The cover 220 is preferably formed by injection molding, and the cover side wall 224 is preferably integrally formed with the cover top wall 222. The cover 220 may be formed from a preferably substantially transparent material, such as a clear plastic material. The case 200 may be provided with a suspension means for preventing contact between a contained article of memorabilia and desired walls of the case 200. For instance, a gasket 502 may be provided to assist in holding the article of memorabilia 500 in a desired orientation within the display cavity 226.

The base 240 generally has a base top wall 242 and a base side wall 244 coupled to or formed integrally with the base top wall 242. On a portion of the base side wall 244, a stacking mechanism 248, such as a stacking lip, may be provided. The base stacking lip 248 of one case 200 is thus designed to cooperate with the cover stacking lip 228 of a second case 200, thereby providing stabilized stackability.

The cover 220 and base 240 are held together in a manually engageable secure relationship by a plurality of security latches 260. Each security latch 260 comprises a security cleat 262 and a cooperating security socket 264. Access to the security latches 260 is preferably obscured by a security flange 266, which may depend from and/or be integrally formed with the cover 220 or the base 240. The case 200 preferably features a means for indicating attempted access or tampering. An example of such means for indicating attempted access or tampering may be the frangible nature of the cover 220, the base 240 or the security flange 266. Thus, materials may be chosen to provide a desired fracture of the cover 220, the base 240 or the security flange 266, upon attempted access to the display cavity 226. In one embodiment, the force required to unlatch the security latches 260, which are preventing access to the display cavity 226, is greater than the force required to cause a fracture visible to the naked eye in the security flange 266. That is, a fracture of the security flange 266 will occur before the security latches 266 release, thereby indicating attempted access to the display cavity 226.

FIGS. 9-12 provide an alternative second embodiment 200 of a memorabilia case according to the present invention. In this embodiment 200, a majority of the display cavity 226 is formed in the base 240, as is a majority of the base display channel 249. This embodiment may be particularly suited for securing an autograph card, picture card, or certificate 500 and an accompanying placard 504.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A memorabilia case comprising:
a cover comprising a cover top wall and a cover side wall coupled to said cover top wall;
a base comprising a base top wall and a base side wall coupled to said base top wall;
at least one locking mechanism, each of said locking mechanisms including cooperating structure on said cover and on said base; and
a security flange adapted to obscure access to said cooperating structure of at least one of said locking mechanisms;
said cover and said base being manually engageable into a locking relationship.

2. A memorabilia case according to claim 1, said cover top wall being formed integrally with said cover side wall.

3. A memorabilia case according to claim 1, said base top wall being formed integrally with said base side wall.

4. A memorabilia case according to claim 1, further comprising a display cavity formed when said cover and said base are engaged in said locking relationship.

5. A memorabilia case according to claim 4, a majority of said display cavity formed by said cover top wall and said cover side wall.

6. A memorabilia case according to claim 4, wherein a majority of said display cavity is formed by said cover top wall.

7. A memorabilia case according to claim 1, said security flange being coupled to said cover.

8. A memorabilia case according to claim 7, said security flange being formed integrally with said cover.

9. A memorabilia case according to claim 1, said base top wall including a display surface, said base further comprising a plurality of support pedestals projecting from said base top wall display surface.

10. A memorabilia case according to claim 9 further comprising a plurality of contact pads adapted to be supported by said support pedestals.

11. A memorabilia case according to claim 9, said support pedestals being spatially arranged to interface to predetermined contact points of a predetermined article of memorabilia.

12. A memorabilia case according to claim 11, said predetermined article of memorabilia being a baseball and said predetermined contact points including the stitched seams of said baseball.

13. A memorabilia case according to claim 1, at least a portion of said cover side wall adapted to interface at least a portion of said base side wall, thereby creating a seam, said locking mechanisms located within said seam.

14. A memorabilia case according to claim 13, said case comprising at least five locking mechanisms, said locking mechanisms spaced circumferentially about said seam.

15. A memorabilia case according to claim 1, said case further comprising a desiccant chamber coupled to said base.

16. A memorabilia case according to claim 15, said case further comprising a display cavity formed when said cover and said base are engaged in said locking relationship, said desiccant chamber formed integrally with said base and in fluid communication with said display cavity.

17. In a case adapted to hold an article of memorabilia, an improvement comprising:
a manually engageable security lock including a cleat, a socket cooperating with said cleat, and a security flange that obscures access to the cooperating junction of said cleat and said socket.

18. An improvement according to claim 17, further including a tamper detection means that indicates attempted access to said case after said security lock has been manually engaged.

19. An improvement according to claim 18, wherein said tamper detection means includes a fracturability of said security flange caused by a separating force of a magnitude less than is required to disengage said security lock.
